(19) United States
(12) Patent Application Publication
(10) Pub. No.: US 2024/0336433 A1
(43) Pub. Date: Oct. 10, 2024

(54) PROPULSION SYSTEM FOR AUTONOMOUS ROBOTS

(71) Applicant: BIONICHIVE LTD, Sapirim, Ind. Park (IL)

(72) Inventor: Liran RAIZER, Ein HaBsor (IL)

(21) Appl. No.: 18/681,579

(22) PCT Filed: Aug. 4, 2022
(86) PCT No.: PCT/IL2022/050847

§ 371 Date: Feb. 6, 2024

Related U.S. Application Data
(60) Provisional application No. 63/230,754, filed on Aug. 8, 2021.

(51) Int. Cl. B65G 1/04; B61C 11/04

(52) U.S. Cl. CPC B65G 1/0492; B61C 11/04

(57) ABSTRACT

Disclosed is a propulsion system for propelling autonomous robots on vertical and horizontal rails that support shelves on which items are stored in a warehouse. The propulsion system changes the principle of travelling on the rails from being dependent on friction between the front wheels and the rail to a system that is dependent on a rack and pinion gear assembly. Also described is a locking assembly that allows the robot to cling to the rails and travel up and along them to reach required destinations on the shelves.

### FIELD OF THE INVENTION

The invention is from the field of autonomous robotic systems serving warehouse and logistics automation. Specifically the invention is from the field of self-driven moving vehicle systems for warehouse automation. More specifically the invention is related to propulsion system of autonomous robots that move items around, inside or outside of a warehouse or inside a logistics truck.

### BACKGROUND OF THE INVENTION

U.S. Pat. No. 10,259,649 assigned to the assignee of the present application describes a warehouse management system. The system comprises inter alia a fleet of autonomous robots used to move items around the warehouse and a shelving system comprising vertical support posts and horizontal rails that support shelves on which the items are stored. The robots comprise a set of on-board sensors, a processor, software, and other electronics configured to provide them with three-dimensional navigation and travel capabilities that enable them to navigate and travel autonomously both along the floor and up and down specially designed vertical rails and along specially designed horizontal rails that either are attached to the existing vertical support posts and horizontal rails of a retrofitted shelving system or replace them in a new shelving system. This ability of the robots to travel in three dimensions allows them to pick items from or place items at any location on the floor or shelving system of the warehouse. In the same manner, the system could also function as an automated pick system by moving, picking and put-away items inside a vehicle.

It is a purpose of the present invention to provide improvements and new features of the rails and the drive assemblies of the robot, that allow the robot to move vertically up and horizontally and cling to the rails while travelling to a designated destination on the shelves.

Further purposes and advantages of this invention will appear as the description proceeds.

### SUMMARY OF THE INVENTION

Disclosed herein is a propulsion system for propelling autonomous robots on terminals, vertical rails and horizontal rails that support shelves on which items are stored in a warehouse or are attached to existing support posts and horizontal rails of a retrofitted shelving system.

The robot comprises two front wheel assemblies and the propulsion system comprises:
a) a drive assembly in each of the front wheel assemblies; the drive assembly comprises an electric motor and gear assembly, which are configured to rotate a front drive wheel on an axle parallel to a surface on which the robot is travelling, thereby propelling the robot on a floor of the warehouse to or from a terminal;
b) at least one pinion gear on an axle, which is parallel to the surface on which the robot is travelling, wherein the electric motor and gear assembly of the drive assembly are configured to rotate the at least one pinion gear on the axle; and
c) a tooth block that extends along the length of the top of each of the vertical rails, horizontal rails, and terminals.

The propulsion system is characterized in that a rack and pinion actuator is formed by meshing the at least one pinion gear in the front wheel assemblies with tooth blocks on the terminals and rails and activating the electric motor and gear drive assembly to rotate the at least one pinion gear; whereupon the rack and pinion actuator propels the robot up and down the terminals and vertical rails and back and forth on horizontal rails.

In embodiments of the propulsion system the tooth block can be made from metal or a type of elastomer. In these embodiments the elastomer can be polyurethane.

In embodiments of the propulsion system the at least one pinion gear in each front wheel assembly is made from metal and the tooth blocks are made from polyurethane.

In embodiments of the propulsion system the tooth block is manufactured separately from the terminals and rails and is firmly attached to them by one of screws, bolts, pins, blind rivets, or bonding.

In embodiments of the propulsion system each front wheel assembly comprises two locking assemblies each of which comprises a frame that supports three small cam rollers on each side of a terminal or rail. The three small cam rollers consist of two parallel cam rollers configured to roll in cam paths in the sides of the terminals and rails and a single lateral cam roller configured to roll against a side of the terminal or rail above the cam path. The small cam rollers keep the robot moving straight and prevent the robot from twisting and falling off the terminal or rail.

Embodiments of the propulsion system comprise a junction between vertical and horizontal rails, wherein the junction comprising a rotating junction rail, which is attached at its center on top of a junction axis and configured to be rotated about the center of the junction, wherein the rotating junction rail has all the features of the upper part of the rails including a tooth block, cam paths, and sides above the cam paths.

In embodiments of the propulsion system the front wheel assemblies each comprise a steering assembly comprised of an electric motor and gear assembly configured to turn the wheel assembly 360 degrees around an axis perpendicular to the surface on which the robot is travelling; thereby rotating the front drive wheel about this vertical axis to steer the robot on the ground and allowing the robot to change its direction of travel on the network of rails. In these embodiments of the propulsion system a robot is able to change its direction of travel on the network of vertical and horizontal rails from vertical to horizontal or vice versa by stopping with its at least one pinion gear engaged with the tooth block on the rotating junction rails in two junctions located at the intersections between a vertical rail and two parallel horizontal rails and then activating both wheel assemblies to rotate the wheel assemblies by a designated angle. Since the wheel assemblies are locked on the rotating junction rails by the locking assemblies in each wheel assembly, the direction of the rotating junction rails are changed allowing the robot to proceed to travel in the new direction.

Embodiments of the propulsion system comprise two pinion gears that are meshed with a spur gear that is configured to cause the pinion gears to rotate. The spur gear is mounted on an axle, which is mounted on the wheel assembly support plate and rotated through a gear train by the electric motor of the drive assembly in each of the front wheel assemblies.

All the above and other characteristics and advantages of the invention will be further understood through the following illustrative and non-limitative description of embodiments thereof, with reference to the appended drawings.

### BRIEF DESCRIPTION OF THE DRAWINGS

FIG. 1 schematically shows the main components of a robot travelling on the floor;

FIG. 2 schematically shows a front view of one of the wheel assemblies;

FIG. 3 schematically shows a section of a rail of the system;

FIG. 4 schematically shows a piece of rail called a terminal;

FIG. 5 schematically shows a locking assembly that locks the robot to the rails;

FIG. 6 schematically shows a robot travelling up a vertical rail;

FIG. 7 schematically shows a junction between vertical and horizontal rails;

FIG. 8 schematically shows a robot that has travelled on horizontal rails to an assigned location on the warehouse shelving system; and

FIGS. 9 to 11 schematically show main components of the propulsion system of the robot.

### DETAILED DESCRIPTION OF EMBODIMENTS OF THE INVENTION

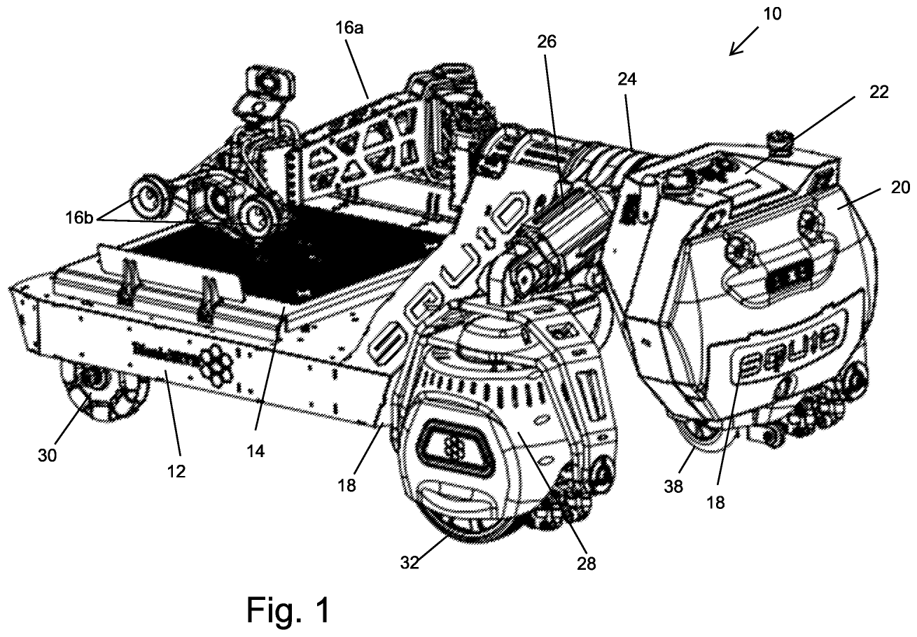

FIG. 1 is a schematic view of the robot 10 of the system of the warehouse system. The robot is basically the same as that described in U.S. Pat. No. 10,259,649; however as in any complex machine, changes are continuously being made to improve performance. Herein below will be described the present invention, which relates to changes made to the rails of the shelving system and the drive wheel assemblies of the robot. The changes made are the inclusion of a toothed tooth block on the shelving rails, pinion gears inside each of the drive wheel assemblies, and newly designed locking assemblies that secure the robot to the rails. These new features change the propulsion system of the robot when travelling on the rails from being dependent on friction between the front wheels and the rail to a system depending on a tooth block and pinion gear; thereby, thereby improving the ability of the robot to cling to the rails and travel up and along them to reach required destinations on the shelves and essentially converting the robot into an advanced form of cog railway that is able to ascend and descend a ninety degree slope.

FIG. 1 schematically shows a side view of the main components of robot 10, which are mounted on a body 12. On top of the body 12 sits a platform or tray 14 on which items are carried by the robot 10. A controllable robotic arm 16a, which in the embodiment shown in the figures is equipped with suction cups 16b, is used to move items to or from tray 14 and the floor or the shelves of the warehouse onto or off of tray 14. At the front of the robot 10 is a head section 20 that houses the processor, software, and other electronics that guide the robot 10 and enable it to carry out its assigned tasks. Visible in the figure on the top surface of head 20 is a control panel 22. In the front of body 12 and head 20 are located power pack cases 18 that house rechargeable power packs that power the robot 10. On-board sensors are located at various locations on the robot 10 to aid the robot 10 in navigation and to identify obstacles. The sensors are of various types, e.g. optical, inductive, magnetic, depth and more. The sensors also service a safety module which allows the robot to be safe enough to operate in a human environment and interact with workers.

Between the power pack case 18 and the head 20 is a neck module 24. The neck module 24 has two expandable shoulder arms 26, each of which is connected to a wheel assembly 28 (only the right hand side shoulder arm unit expandable shoulder arm 26 is visible in FIG. 1). An electric motor and gear system (not shown) can rotate the expandable shoulder arm 26 synchronically clockwise or counterclockwise to allow robot 10 to travel either horizontally on the floor or along a shelf or vertically up or down a vertical rail or 180 degrees to allow it to drive on the ceiling, as described in U.S. Pat. No. 10,259,649.

Robot 10 moves along the floor on four wheels. In the embodiment currently in use the rear wheels 30 are multi directional wheels which allow movement to any direction, about an axis perpendicular to the floor. In this embodiment the wheel assemblies 28 dictate the steering angle and differential speeds of the rear wheels. A driving assembly and a steering assembly in each wheel assembly 28 independently rotates its respective driving and steering unit wheel assembly 28 in any direction and controls the forward and reverse speed of travel of each of the front drive wheels. With this arrangement the robot is completely autonomous and can be steered by its control system to any location on the floor of the warehouse without the use of a tooth block, embedded wire or any other arrangement to guide it.

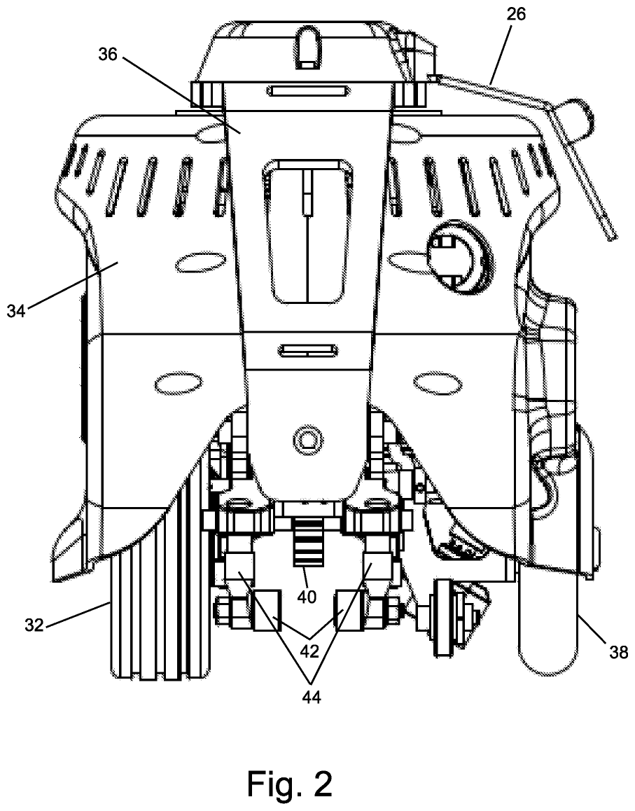

FIG. 2 schematically shows a front view of one of the wheel assemblies 28. A wheel cover 34, which surrounds the internal components of wheel assembly 28, is attached by an arc gimbal system 36 connected to one of the expandable shoulder arms 26 of the neck module 24 of robot 10. The way in which expandable shoulder arm 26 can be rotated, expanded and contracted to allow the robot to climb and descend the rails and adapt itself to storage units having different vertical distances between the shelves is explained in detail in the aforementioned U.S. Pat. No. 10,259,649.

Seen in FIG. 2 at the lower part of the wheel assembly 28 visible under wheel cover 34, which is a removable cover that protects the components inside wheel assembly 28 from dirt, mechanical damage, and for safety reasons, are front drive wheel 32 and front support wheel 38. Front drive wheel 32 is driven by an electric motor and gear assembly to propel robot 10 on the warehouse floor. Front support wheel 38 is not powered. When robot 10 travels on the floor front support wheel 38 rotates freely and its function is to add stability to robot 10 where it functions as a counter balance to the weight of the robot, which is supported by the front drive wheel 32. Also seen in FIG. 2 are the following components that allow robot 10 to travel on a rail: a pinion gear 40, which is a component of the drive assembly in wheel assembly 28, and small cam rollers 42, which are components of a locking assembly 44. These components will be described in detail herein below.

Inside its wheel cover 34, each wheel assembly 28 comprises a steering assembly and a drive assembly. The steering assembly is comprised of an electric motor and gear assembly, which turns the wheel assembly 28 up to 360 degrees around an axis perpendicular to the surface on which the robot 10 is travelling, thereby rotating front drive wheel 32 about this axis to steer the robot. The drive assembly is comprised of a second electric motor and gear assembly, which is configured to rotate the front drive wheel 32 around an axle parallel to the surface on which the robot 10 is travelling thereby causing the robot 10 to move in the direction that the wheel assembly 28 has been pointed by the steering assembly. At least the motor of the drive assembly is a variable speed motor, which allows the robot to travel at different speeds. When travelling on the floor it is also possible to steer the robot 10 by activating the motors of the two drive assemblies to produce differential rotational speeds of the two front drive wheels 32.

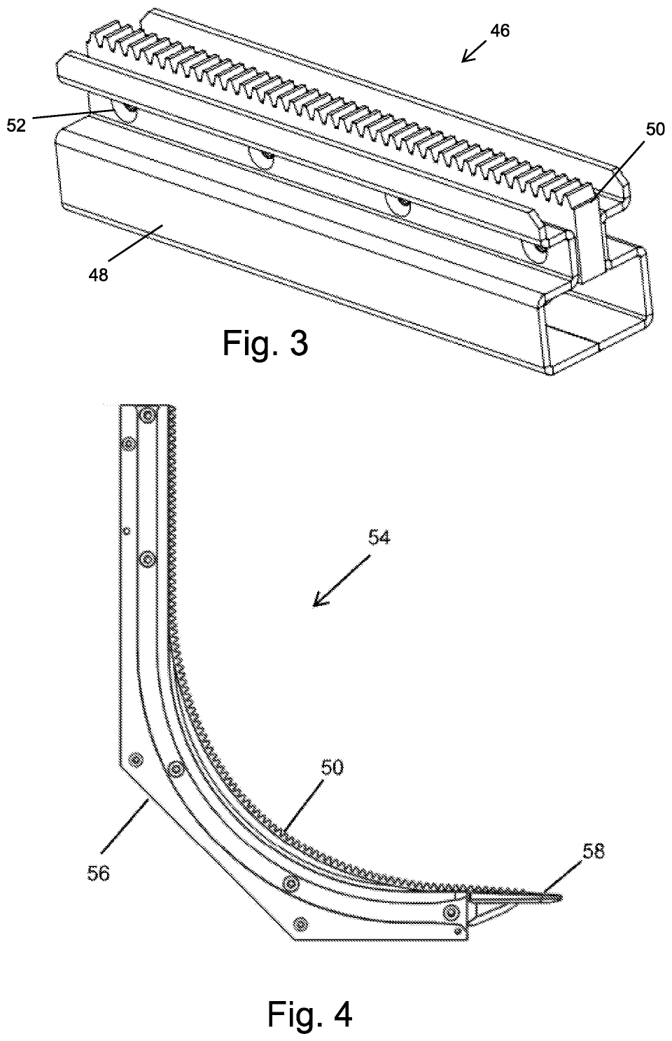

FIG. 3 schematically shows a section of a rail 46 of the system of the present invention. The rails 46 are designed to be easily attached by conventional means such as bolts, fasteners or quick-lock mounts to existing shelving in a warehouse to be retrofitted to employ robots 10. In another embodiment of a warehouse, the rails 46 are not attached to existing shelving but are constructed as a free standing structure that stands next to and parallel to the existing shelving. Alternately, the robots 10 can obviously be used in new buildings or existing buildings repurposed to become warehouses, in which case the rails 46 can be manufactured as an integral feature of a new shelving system. Rails 46 can also be mounted on walls or ceiling without any shelf alongside.

In the system of U.S. Pat. No. 10,259,649 the rails are made from “U”-shaped profiles and the drive wheels of the robot entered into the space between the sides of the “U”. The robot moves on the rails by friction between the drive wheel and the bottom of the “U”.

In the present invention, the rails 46 are comprised of a profile 48 containing a linear toothed gear, called herein a tooth block 50 for convenience, which, when meshed with two pinion gears 40 (see FIGS. 2 and 11) in the wheel assembly 28, form a rack and pinion actuator that propels the robot 10 up, down, and across the shelves.

The vertical and horizontal rails 46 have identical shape seen most clearly in FIG. 3. The profiles 48 are made from different types of material, e.g. aluminum, steel, polymeric materials, and elastomeric materials with different properties depending on the requirements.

The tooth block 50 can be made from metal or a type of elastomer, e.g. polyurethane. Tooth block 50 is usually manufactured separately from profile 48 and is firmly attached to it by any means known in the art, i.e. screws, bolts, pins, blind rivets, or bonding. A most convenient method is to create preformed connecting holes 52 in the profile 48 and matching connecting holes in the tooth block 50. Bolts, pins or blind rivets can then be inserted into the connecting holes 52 to attach the tooth block 50 to the profile 48. A polyurethane tooth block 50 has the following advantages over a tooth block made from metal:
The pinion gears 40 that mesh with the teeth of the tooth block 50 are metal. Metal gears moving on a metal tooth block 50 create vibration and a great deal of noise, which with many robots active in a warehouse can reach intolerable levels. Using a tooth block made of an elastomeric material, e.g. polyurethane, mitigates nearly to the point of eradicating vibration and noise.
A pinion gear rolling on a metal tooth block, as in a conventional metal-to-metal rack and pinion gear, requires lubrication to minimize friction, wear and tear. In contras a metal pinion rolling on a non-metallic tooth block would not require any lubrication, thereby keeping the warehouse cleaner and environmentally healthier.
Because polyurethane is flexible the teeth of tooth block 50 can bend slightly to mesh with those on the metal pinion gears 40, therefore the manufacturing tolerances for creating the teeth in a polyurethane tooth block 50 can be less restrictive than those for creating teeth in a metal tooth block 50.
A polyurethane tooth block 50 can be produced by extrusion and formed into a roll having a very long length, shipped separately from the profile 48 and cut to the required length on-site during retrofitting an existing shelving system or constructing a new one.
Polyurethane is lighter than metal reducing the weight of the horizontal rails on the shelves allowing identical shelves to support more weight.

FIG. 4 schematically shows a piece of rail called a terminal 54, which is attached to the bottoms of the vertical rails 46, near where they reach the floor. For safety reasons and because robot 10 must be mechanically locked to rails, terminals 54 are the only system components where robots 10 can connect or disconnect from the rails 46 in order to climb to or descend from the shelves. Terminals 54 have a shape 56 with a curved upper surface having the features of profiles 48 of rails 46 to which tooth blocks 50 are attached. A flexible tip 58 of tooth block 50 at the front of the terminal 54 slides into a space above cam rollers 42 and under pinion gear 40 on the front of the drive and steering unit wheel assembly 28 (see FIG. 2) to insure that the pinion gears 40 are properly aligned to mesh with the teeth on tooth block 50.

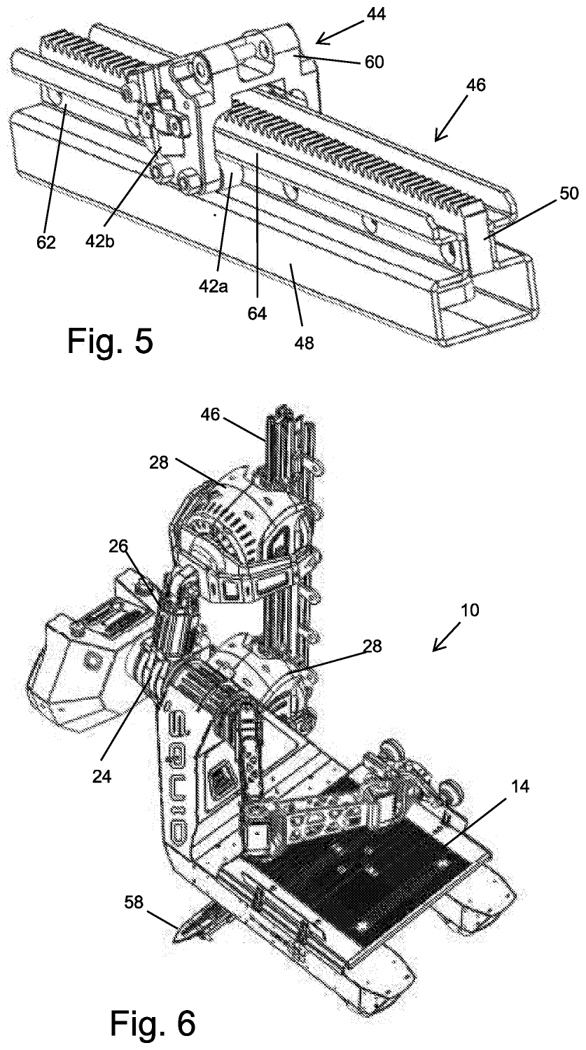

FIG. 5 schematically shows one of two locking assemblies 44 that are located inside each of the wheel assemblies 28 of robot 10. Locking assembly 44 comprises a frame 60 that supports a total of six small cam rollers 42—three small cam rollers 42 on each side of rail 46. Two parallel cam rollers 42a (only one of these parallel cam rollers 42a is visible in the figure) roll in cam paths 62 in the side of profile 48 and a single lateral cam rollers 42b rolls against a side 64 of profile 48 above cam path 62. The three small cam rollers 42 roll along the profile 56 of the terminal 54 and profiles 48 of rails 46 to keep robot 10 moving straight and prevent robot 10 from twisting and falling off the terminal or rail.

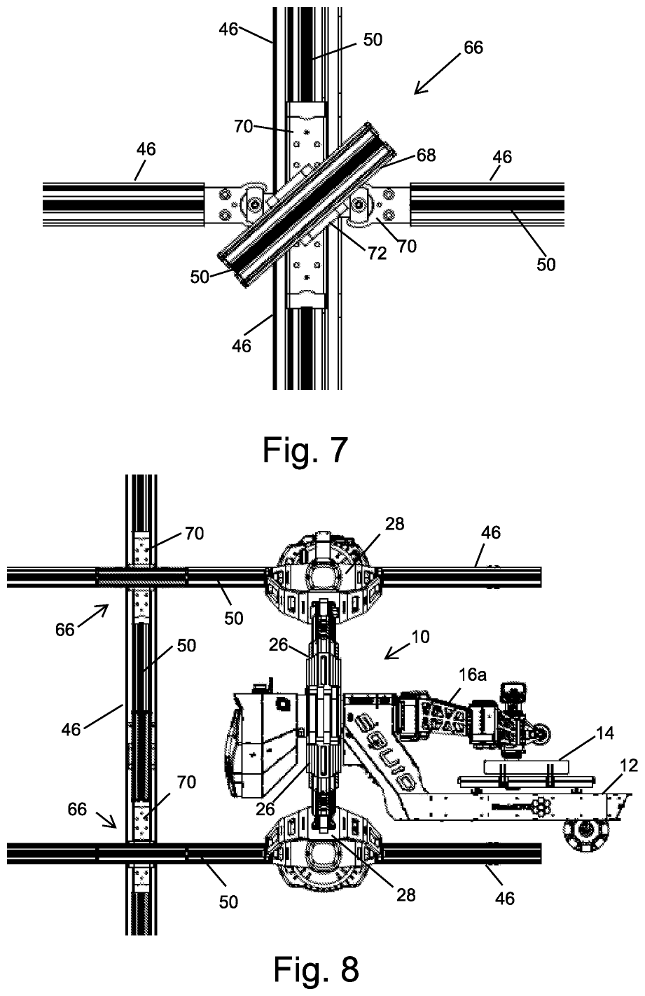

In order to carry out a mission in the warehouse, components on robot 10 execute a series of distinct steps. The process is very similar to the one described and illustrated in U.S. Pat. No. 10,259,649. This process, adapted mutandis mutatis for the robot of the present invention, is broken down into the following steps:
a) The set of on-board sensors guide the steering assembly and the drive assembly in the wheel assemblies 28 to travel to the designated terminal 54 of vertical rail 46 that the robot has been instructed to ascend to reach one of the shelves in the warehouse.
b) A sensor, e.g. an optical sensor, is activated as robot 10 approaches the designated terminal 54 and stops the robot at an exact position relative to flexible tip 58 of terminal 54.
c) The electric steering motors in the steering assembly of wheel assemblies 28 are activated to turn both wheel assemblies 28 by ninety degrees so that they are facing the flexible tip 58 of the tooth block 50 at the front of terminal 54.
d) The drive assemblies in the wheel assemblies 28 are activated to advance the robot 10 until the flexible tip 58 at the front of terminal 54 enters into the space in the leading wheel assembly 28 seen in FIG. 2 below pinion gear 40. As robot 10 moves onto terminal 54, the multi directional rear wheels 30 wheels keep the tray 14 of the robot 10 parallel to the floor and shelves.
e) Synchronized movements takes place between the driving motors of the drive assembly in the wheel assemblies 28 and the expandable shoulder arms 26. These movements advance the leading wheel assembly 28 onto the terminal 54, meshing the two pinion gears 40 with the tooth block 50. As the robot progresses, the small cam rollers 42 of locking assembly 44 make contact with the terminal to lock drive and steering unit onto the terminal 54.
f) As the leading wheel assembly 28 moves further up terminal 54 and onto vertical rail 46, synchronized movement between the driving motor of the leading wheel assembly 28, the driving motor of the following wheel assembly 28, and the neck module 24 allow the robot 10 to move on the floor towards the terminal 54 while the tray 14 of robot 10 remains parallel to the floor and shelves.
g) When the following wheel assembly 28 reaches the terminal 54 the flexible tip 58 of the tooth block 50 at the front of terminal 54 enters into the space in the front wheel assembly 28 seen in FIG. 2 below pinion gear 40, the two pinion gears 40 mesh with the tooth block 50, and the small cam rollers 42 of locking assembly 44 make contact with the terminal to lock the following wheel assembly 28 onto the terminal 54.
h) With both wheel assemblies 28 locked on the rail 50 and terminal 60, the rotating pinion gears 40 in the wheel assemblies 28 propel the robot 10 up vertical rail 46 until the leading wheel assembly 28 reaches a junction 66 (see FIG. 7) with the shelf on which the item to be picked up is located.
i) Now the steering assemblies in both wheel assemblies 28 are activated to rotate the rotating junction rails 68 by a designated angle, for ex. ninety degrees, and the drive assemblies are activated to rotate the pinion gears 40 propelling the robot 10 along the horizontal rail 46 parallel to the shelf (see FIG. 7).
j) In order to complete its mission of removing an item from (or delivering an item to) a specific location on a shelf the robot 10 travels vertically with both wheel assemblies 28 in the same vertical rail 46 and travels horizontally with one of its wheel assemblies 28 on a horizontal rail that is attached to the shelf on which the item is located and the other wheel assembly 28 on a horizontal rail that is attached to the shelf above (or below) the first shelf (see FIG. 8).
k) When the robot arrives at the designated location of the item to be collected, the expandable shoulder arms 26 of neck module 24 are activated if necessary (for example if the item to be picked is located on top of another item at the same location on the shelf) to bring the tray 14 of robot 10 to the same height above the floor as the bottom of the item to be picked and the controllable moving robotic arm 16a is activated to pull the item onto the tray 14.
l) With the item safely on tray 14, steps a to k are performed in reverse order to return the robot 10 to the floor and to deliver the item to a designated location in the warehouse.

FIG. 6 symbolically shows robot 10 travelling up a vertical rail 46 towards a junction 66 in step h.

FIG. 7 schematically shows a junction 66 between vertical and horizontal rails. The junction 66 is comprised of junction base bracket 70 that is connected to sections of vertical rail 46 and sections of horizontal rail 46 whose intersection forms junction 66. A junction axle 72 is attached to a pivot at the center of the junction base bracket 70 so that junction axle 72 and a rotating junction rail 68, which is attached at its center on top of junction axle 72 can be rotated about the center of the junction 66. The rotating junction rail 68 has all the features of the upper part of rails 46, i.e. tooth block 50, cam paths 62, and sides 48 above cam paths 62.

The dimensions of junction base bracket 70, the junction axis 72, and the rotating junction rail 68 are such that rotating junction rail 68 can be alternately perfectly lined up with one or two sections of vertical rail 46 or one or two sections of horizontal rail 46.

A robot 10 is able to change its direction of travel on the network of vertical and horizontal rails from vertical to horizontal or vice versa by stopping with its pinion gears 40 engaged with the tooth block 50 on the rotating junction rail 68 in two junctions 66 located at the intersections between a vertical rail and two horizontal rails (see FIG. 8). Then robot 10 activates both wheel assemblies 28 to cause them to rotate by a designated angle. Since the wheel assemblies 28 are locked on the rotating junction rail 68 by the two locking assemblies in each wheel assembly 28, the direction of the rotating junction rail 68 is changed allowing the robot 10 to proceed to travel in the new direction. In case the robot 10 approaches a junction in which the rotating junction rail 68 is oriented perpendicularly to the robot's 10 direction of travel, then an electrical or mechanical arrangement, e.g. a push rod located at the junction, against which a component of the wheel assembly 28, e.g. one of the cam rollers 42, pushes against when the robot 10 gets close to the junction, or a sensor on the robot, which activates a small motor in junction 66. As said the locking assemblies 44 in each wheel assembly 28 prevent the robots 10 from disengaging from the rails 46 during the maneuver carried out at the junction.

FIG. 8 schematically shows a robot 10 that has traveled up a vertical rail 46, changed direction at junctions 66 and then travelled on horizontal rails 46 to an assigned location on a shelf of the warehouse shelving system. As shown in the figure, each of the wheel assemblies 28 is attached to the profile of their respective horizontal rail 46, by the locking units as described herein above. The length and angle of the expandable shoulder arms 26 are adjusted such that body 12 and tray 14 are parallel to the horizontal rails 46 with the tray 14 and controllable moving robotic arm 16a opposite the item on the shelf (not shown in the figure) to be transferred to the robot 10 in order to be delivered to another location in the warehouse.

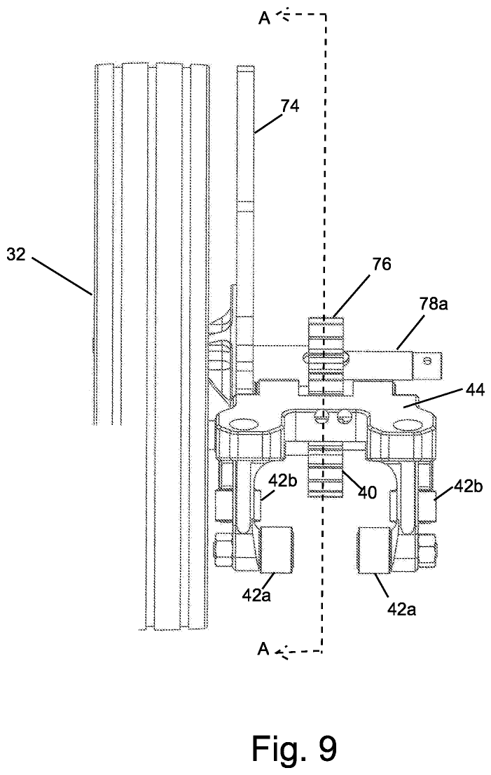

FIGS. 9 to 11 schematically show main components of the propulsion system on the robot.

FIG. 9 is a front view of components of the drive assembly of the right hand wheel assembly 28 of robot 10. (Left hand wheel assembly 28 of robot 10 has the same components as would be shown in a mirror image of FIG. 9; therefore they will not be described herein.) Seen in the figure are front drive wheel 32 and a wheel assembly support plate 74 that supports many of the interior components of wheel assembly 28. A single electric drive motor (not seen in the figures) provides the propulsive force to rotate front driving wheel 32 via a main gear 82 (see FIG. 11) and other gears. Front driving wheel 32, in conjunction with the front driving wheel in the left hand wheel assembly 28 propel robot 10 when travelling on the floor. Axle 78a on which is mounted spur gear 76 is rotated also by the same electric motor through a gear train. Spur gear 76 meshes with two pinion gears 40 causing them to rotate and, when meshed with the tooth block 50 in the rails, to propel the robot when travelling on the rails 46. Also seen is one of the locking assemblies 44 that are in the wheel assembly 28, and one of the parallel cam rollers 42a that rolls in cam paths 62 in both sides of profile 48 of rails 46 and lateral cam rollers 42b that rolls against sides 64 on both sides of profile 48 above cam paths 62 (see FIG. 5).

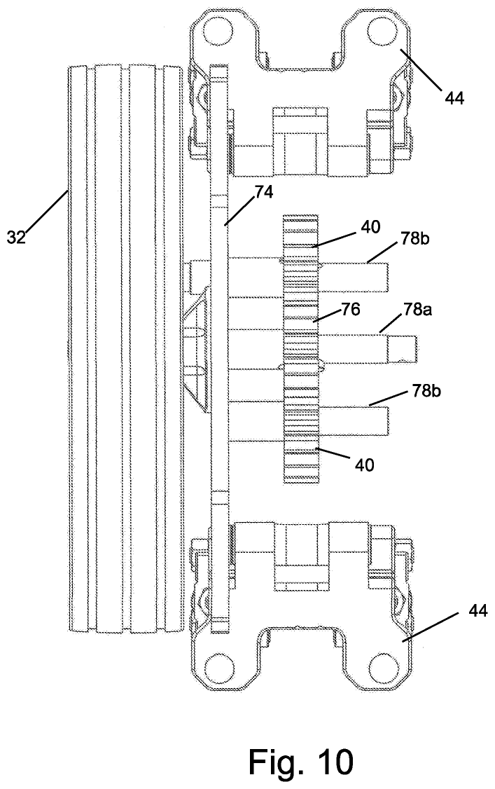

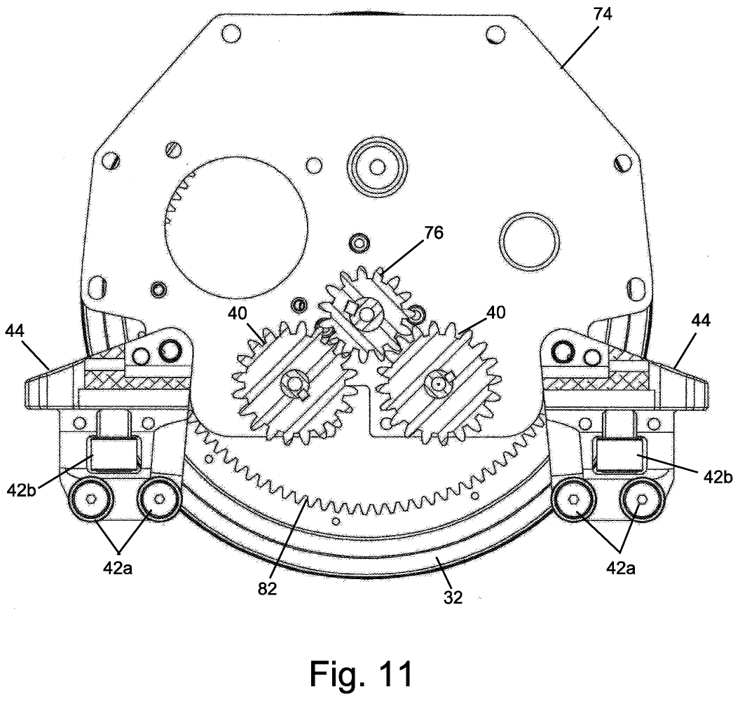

FIG. 10 is a top view of FIG. 9. In this figure are seen the two locking assemblies 44, one at the front of the wheel assembly 28 and one at the rear. The front locking assembly 44 is needed to provide instant attachment to the terminal 54 when the robot approaches to begin ascending a vertical rail and the back locking assembly 44 retains its grip on the terminal 44 rail 46 until the robot 10 has completely descended to the floor. The two pinion gears 40 are mounted on bearings on axles 78b and rotated by spur gear 76 mounted on axle 78a, which is rotated by the electric motor in the wheel assembly 28.

FIG. 11 is a cross-sectional view taken along the plane of line A-A in FIG. 9. Seen in the figure are the two locking assemblies 44, each with two parallel cam rollers 42a that move in the cam path 62 and one lateral cam roller 42b that contacts side 64 on one of the sides of the profile 56 of terminal 54, the profile 48 of rails 49, and of the rotating junction rail 68 in junction 66. Also seen are the two pinion gears 40 meshed with spur gear 76 that causes them to rotate. In principle only one pinion gear 40 could be used in which case the spur gear 76 would not be necessary and the single pinion gear 40 could be rotated by the electric motor and gears of the drive assembly. In practice two pinion gears 40 provide a redundant and safe design. This is because, in the event teeth of the tooth block gear 50 are missing as a result of a failure or being intentionally left out to allow free movement of the rotating junction rail 68, then, if there were only one pinion gear 40, the robot would cease moving. With two pinion gears 40 that are spaced apart, when the first pinion gear reaches a missing tooth (or more depending on the distance between the pinion gears) the second pinion gear 40 continues providing the propelling force until the first pinion gear 40 passes the break and the first pinion gear 40 then provides the propelling force until the second pinion gear 40 passes the missing tooth. This arrangement also prevents stalling if a small gap exists between sections of tooth block 50, for example at junctions 66 and also decreases the force on each tooth in the tooth block 50 since it distributes the force between more than a single tooth as in a conventional rack and pinion gear. Seen below wheel assembly support plate 74 is gear 82 that rotates the front drive wheel 32.

Not shown in any of the figures are brake assemblies that comprise normally closed brakes that act to lock the driving wheels 32 and pinion gears 40 in case of mechanical or electrical failure, whether robot 10 is travelling on the floor or on the rails. There are two brake assemblies, one in each wheel assembly 28, to provide redundancy of this very important safety feature, especially when the robot is ascending or descending a vertical rail.

Although embodiments of the invention have been described by way of illustration, it will be understood that the invention may be carried out with many variations, modifications, and adaptations, without exceeding the scope of the claims.

1. A propulsion system for propelling autonomous robots on terminals, vertical rails and horizontal rails that support shelves on which items are stored in a warehouse or are attached to existing support posts and horizontal rails of a retrofitted shelving system;
wherein, the robot comprises two front wheel assemblies; and
wherein, the propulsion system comprises:
a) a drive assembly in each of the front wheel assemblies, the drive assembly comprises an electric motor and gear assembly, which are configured to rotate a front drive wheel on an axle parallel to a surface on which the robot is travelling, thereby propelling the robot on a floor of the warehouse to or from a terminal;
b) at least one pinion gear on an axle, which is parallel to the surface on which the robot is travelling, wherein the electric motor and gear assembly of the drive assembly are configured to rotate the at least one pinion gear on the axle; and
c) a tooth block that extends along the length of the top of each of the vertical rails, horizontal rails, and terminals;
the propulsion system characterized in that:
a rack and pinion actuator is formed by meshing the at least one pinion gear in the front wheel assemblies with tooth blocks on the terminals and rails and activating the electric motor and gear drive assembly to rotate the at least one pinion gear; whereupon the rack and pinion actuator propels the robot up and down the terminals and vertical rails and back and forth on horizontal rails.

2. The propulsion system of claim 1, wherein the tooth block is made from metal or a type of elastomer.

3. The propulsion system of claim 2, wherein, the elastomer is polyurethane.

4. The propulsion system of claim 3, wherein the at least one pinion gear in each front wheel assembly is made from metal and the tooth blocks are made from polyurethane.

5. The propulsion system of claim 1, wherein the tooth block is manufactured separately from the terminals and rails and is firmly attached to them by one of screws, bolts, pins, blind rivets, or bonding.

6. The propulsion system of claim 1, wherein each front wheel assembly comprises two locking assemblies each of which comprises a frame that supports three small cam rollers on each side of a terminal or rail, wherein the three small cam rollers consist of two parallel cam rollers configured to roll in cam paths in the sides of the terminals and rails and a single lateral cam roller configured to roll against a side of the terminal or rail above the cam path; wherein the small cam rollers keep the robot moving straight and prevent the robot from twisting and falling off the terminal or rail.

7. The propulsion system of claim 1, comprising a junction between vertical and horizontal rails, wherein the junction comprising a rotating junction rail, which is attached at its center on top of a junction axis and configured to be rotated about the center of the junction, wherein the rotating junction rail has all the features of the upper part of the rails including a tooth block, cam paths, and sides above the cam paths.

8. The propulsion system of claim 7, wherein the front wheel assemblies each comprise a steering assembly comprised of an electric motor and gear assembly configured to turn the wheel assembly 360 degrees around an axis perpendicular to the surface on which the robot is travelling, thereby rotating the front drive wheel about this axis to steer the robot on the ground and allowing the robot to change its direction of travel on the network of rails.

9. The propulsion system of claim 8, wherein a robot is able to change its direction of travel on the network of vertical and horizontal rails from vertical to horizontal or vice versa by stopping with its at least one pinion gear engaged with the tooth block on the rotating junction rails in two junctions located at the intersections between a vertical rail and two parallel horizontal rails and then activating both wheel assemblies to rotate the wheel assemblies by a designated angle; wherein, since the wheel assemblies are locked on the rotating junction rails by the locking assemblies in each wheel assembly, the direction of the rotating junction rails are changed allowing the robot to proceed to travel in the new direction.

10. The propulsion system of claim 1, comprising two pinion gears that are meshed with a spur gear that is configured to cause the pinion gears to rotate, wherein the spur gear is mounted on an axle, which is mounted on the wheel assembly support plate and rotated through a gear train by the electric motor of the drive assembly in each of the front wheel assemblies.
